(19) United States
(12) Patent Application Publication
(10) Pub. No.: US 2023/0017060 A1
(43) Pub. Date: Jan. 19, 2023

(54) TRANSMISSION POINT CONFIGURATION METHOD AND APPARATUS, AND COMMUNICATIONS DEVICE

(71) Applicant: VIVO MOBILE COMMUNICATION CO., LTD., Dongguan (CN)

(72) Inventor: Yumin WU, Dongguan (CN)

(73) Assignee: VIVO MOBILE COMMUNICATION CO., LTD., Dongguan (CN)

(21) Appl. No.: 17/950,095

(22) Filed: Sep. 21, 2022

Related U.S. Application Data
(63) Continuation of application No. PCT/CN2021/082288, filed on Mar. 23, 2021.

(30) Foreign Application Priority Data
Mar. 24, 2020 (CN) 202010214526.5

(51) Int. Cl. H04L 5/00; H04W 24/02; H04W 76/19

(52) U.S. Cl. CPC H04L 5/0035; H04W 24/02; H04L 5/0094; H04W 76/19

(57) ABSTRACT

A transmission point configuration method and apparatus and a communications device are provided. The transmission point configuration method is performed by a user equipment and includes receiving configuration information from a network side device. The configuration information is for a plurality of transmission points of one configuration object. The configuration object includes a serving cell or a bandwidth part. The configuration information includes physical identifiers of the transmission points; and performing configuration on the plurality of transmission points of the configuration object based on the configuration information.

### CROSS-REFERENCE TO RELATED APPLICATIONS

This application is a continuation of International Application No. PCT/CN2021/082288, filed on Mar. 23, 2021, which claims priority to Chinese Patent Application No. 202010214526.5 filed on Mar. 24, 2020. The entire contents of each of the above-referenced applications are expressly incorporated herein by reference.

### TECHNICAL FIELD

The present disclosure relates to the field of communications technologies, and in particular, to a transmission point configuration method and apparatus, and a communications device.

### BACKGROUND

In a conventional technology, user equipment (UE) can only be configured with a plurality of cells having different frequency points. However, when the UE needs to work at a plurality of transmission points (TRPs) on a same frequency, the UE needs to be capable of transmitting and receiving data at the plurality of nodes, but a related technology has not provided a solution for data transmission and reception at a plurality of transmission points.

### SUMMARY

Embodiments of the present disclosure provide a transmission point configuration method and apparatus, and a communications device, to ensure effective data transmission and reception of UE at a plurality of transmission points.

According to a first aspect, the embodiments of the present disclosure provide a transmission point configuration method, applied to user equipment. The method includes:

receiving configuration information from a network side device, where the configuration information is for a plurality of transmission points of one configuration object, the configuration object includes a serving cell or a bandwidth part, and the configuration information includes physical identifiers of the transmission points; and

performing configuration on the plurality of transmission points of the configuration object based on the configuration information.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

According to a second aspect, the embodiments of the present disclosure further provide a transmission point configuration method, applied to a network side device. The method includes:

transmitting configuration information to user equipment, where the configuration information is for a plurality of transmission points of one configuration object, the configuration object includes a serving cell or a bandwidth part, and the configuration information includes physical identifiers of the transmission points.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

According to a third aspect, the embodiments of the present disclosure further provide a transmission point configuration apparatus, applied to user equipment. The apparatus includes:

a receiving module, configured to receive configuration information from a network side device, where the configuration information is for a plurality of transmission points of one configuration object, the configuration object includes a serving cell or a bandwidth part, and the configuration information includes physical identifiers of the transmission points; and

a configuring module, configured to perform configuration on the plurality of transmission points of the configuration object based on the configuration information.

According to a fourth aspect, the embodiments of the present disclosure further provide a transmission point configuration apparatus, applied to a network side device. The apparatus includes:

a transmitting module, configured to transmit configuration information to user equipment, where the configuration information is for a plurality of transmission points of one configuration object, the configuration object includes a serving cell or a bandwidth part, and the configuration information includes physical identifiers of the transmission points.

According to a fifth aspect, the embodiments of the present disclosure further provide a communications device, where the communications device includes a processor, a memory, and a computer program that is stored in the memory and that can run on the processor, and steps of the transmission point configuration method described above are implemented when the processor executes the computer program.

According to a sixth aspect, the embodiments of the present disclosure provide a computer-readable storage medium, where the computer-readable storage medium stores a computer program, and steps of the transmission point configuration method described above are implemented when the computer program is executed by a processor.

According to a seventh aspect, the embodiments of the present disclosure provide a computer program product, stored in a computer-readable storage medium, and steps of the transmission point configuration method described above are implemented when the computer program product is executed by at least one processor.

According to an eighth aspect, the embodiments of the present disclosure provide a communications device, where the communications device is configured to perform steps of the transmission point configuration method described above.

In the foregoing solutions, the network side device transmits, to the user equipment, the configuration information for the plurality of transmission points of one configuration object. The user equipment may perform configuration on the plurality of transmission points of the configuration object based on the configuration information. According to the technical solutions in the embodiments, a plurality of transmission points may be configured for the user equipment along with proper resource reservation, thereby ensuing more effective data transmission and reception of the user equipment at the plurality of transmission points.

### BRIEF DESCRIPTION OF DRAWINGS

Technical solutions of embodiments of the present disclosure are described together with accompanying drawings. The following briefly describes the accompanying drawings. Apparently, the accompanying drawings in the following description show merely some embodiments of the present disclosure, and those of ordinary skill in the art may still derive other drawings from these accompanying drawings without creative efforts.

FIG. 1 is a block diagram of a mobile communications system to which an embodiment of the present disclosure is applicable;

FIG. 2 is a schematic diagram of carrier aggregation;

FIG. 3 is a schematic flowchart of a transmission point configuration method applied to user equipment according to an embodiment of the present disclosure;

FIG. 4 is a schematic flowchart of a transmission point configuration method applied to a network side device according to an embodiment of the present disclosure;

FIG. 5 is a schematic structural diagram of a module of user equipment according to an embodiment of the present disclosure;

FIG. 6 is a schematic structural diagram of a module of a network side device according to an embodiment of the present disclosure;

FIG. 7 is a schematic composition diagram of user equipment according to an embodiment of the present disclosure; and

FIG. 8 is a schematic composition diagram of a network side device according to an embodiment of the present disclosure.

### DETAILED DESCRIPTION

Exemplary embodiments of the present disclosure will be described below in further detail in conjunction with the accompanying drawings. Although the exemplary embodiments of the present disclosure are shown in the accompanying drawings, it should be understood that the present disclosure may be implemented in various forms without being limited to the embodiments described herein. On the contrary, these embodiments are provided to enable a more thorough understanding of the present disclosure and to fully convey the scope of the present disclosure to those skilled in the art.

The terms “first”, “second”, or the like in the description and the claims of this application are used to distinguish similar objects, instead of describing a specific sequence or order. It should be understood that data termed in such a way is interchangeable in proper circumstances so that the embodiments of this application described herein can be implemented in an order other than the order illustrated or described herein. In addition, the terms “include/include”, “have”, and any variants thereof are intended to cover non-exclusive inclusion, for example, processes, methods, systems, products, or devices that contain steps or units are not necessarily limited to those steps or units that are clearly listed, but may include other steps or units that are not clearly listed or are inherent to these processes, methods, products, or devices. “And/or” used in the description and the claims means at least one of the connected objects.

The technology described in this specification is not limited to the long term evolution (LTE)/LTE-Advanced (LTE-A) system. It can also be applied to various wireless communications systems, such as a system of code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” are often interchangeably used. A CDMA system may implement a radio technology, for example, CDMA 2000 or Universal Terrestrial Radio Access (UTRA). UTRA includes wideband CDMA (WCDMA) and another CDMA variation. A TDMA system may implement a radio technology, for example, Global System for Mobile Communication (GSM). An OFDMA system can implement radio technologies, such as ultra mobile broadband (UMB), evolved-UTRA (E-UTRA), IEEE 802.11 (Wi-Fi), IEEE 802.16 (WiMAX), IEEE 802.20, and Flash-OFDM. UTRA and E-UTRA are a part of a universal mobile telecommunications system (UMTS). LTE and more advanced LTE (for example, LTE-A) are new UMTS versions that use E-UTRA. UTRA, E-UTRA, UMTS, LTE, LTE-A, and GSM are described in documents from the organization named the “3rd Generation Partnership Project (3GPP)”. CDMA2000 and UMB are described in the documents of the organization named the “3rd Generation Partnership Project 2” (3GPP2). The technologies described in this specification may be used in the systems and radio technologies mentioned above, and may also be used in another system and radio technology. However, an NR system is described in the following description for illustrative purposes, and the terminology in NR is used in most of the following description, though these technologies may also be applied to applications other than NR system applications.

The following description provides examples and does not limit the scope, applicability, or configuration set forth in the claims. Changes may be made to functions and arrangements of elements discussed herein without departing from the spirit and scope of the present disclosure. In various examples, various procedures or components may be omitted, replaced, or added if appropriate. For example, the described method may be performed according to a sequence different from the described sequence, and various steps may be added, omitted, or combined. In addition, features described with reference to some examples may be combined in other examples.

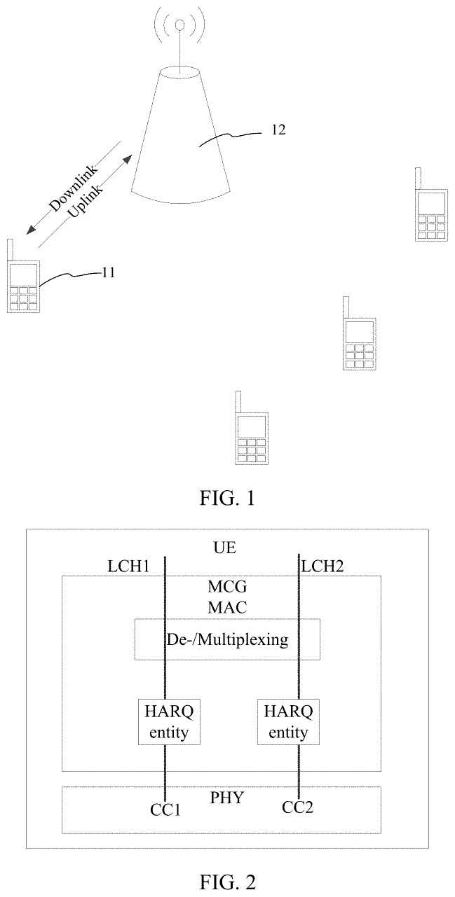

Refer to FIG. 1. FIG. 1 is a block diagram of a wireless communications system to which an embodiment of the present disclosure is applicable. The wireless communications system includes user equipment 11 and a network side device 12. Where the user equipment 11 may also be referred to as a terminal device or terminal, and the user equipment 11 may be a mobile phone, a tablet personal computer, a laptop computer, a personal digital assistant (PDA), a mobile internet device (MID), a wearable device, a vehicle-mounted device or other terminal side devices. It should be noted that a specific type of the user equipment 11 is not limited in the embodiments of the present disclosure. The network side device 12 may be a base station or a core network, where the base station may be a base station in 5G or a later version (for example, gNB or 5G NR NB), a base station in another communications system (for example, an evolved node B (eNB), a WLAN access point, or another access point), or a location server (for example, E-SMLC or location manager function (LMF)). The base station may be referred to as a node B, an evolved node B, an access point, a base transceiver station (BTS), a radio base station, a radio transceiver, a basic service set (BSS), an extended service set (ESS), an eNB, a home node B, a home evolved node B, a WLAN access point, a Wi-Fi node, or another appropriate term in the art. As long as same technical effects are achieved, the base station is not limited to a specified technical term. It should be noted that, in the embodiments of the present disclosure, a base station in the NR system alone is used as an example, but a specific type of the base station is not limited.

The base station can communicate with the user equipment 11 under the control of a base station controller. In various examples, the base station controller may be a part of the core network or some base stations. Some base stations may perform communication of control information or user data with the core network through backhaul. In some examples, some of the base stations may directly or indirectly communicate with each other by a backhaul link, and the backhaul link may be a wired or wireless communication link. A wireless communications system may support operations on a plurality of carriers (wave signals with different frequencies). A multi-carrier transmitter can transmit a modulated signal on the plurality of carriers simultaneously. For example, each communication link may be a multi-carrier signal modulated based on various radio technologies. Each modulated signal can be sent over different carriers and can carry control information (for example, a reference signal or a control channel), overheads information, data, and the like.

The base station can perform wireless communication with the user equipment 11 through one or more access point antennas. Each base station may provide communication overlay to a corresponding coverage area of the base station. A coverage area of an access point may be divided into sectors that form merely a part of the coverage area. The wireless communications system may include different types of base stations (for example, a macro base station, a micro base station, or a pico base station). The base station can also use different radio technologies, such as cellular or WLAN radio access technologies. The base station can be associated with the same or different access networks or operator deployment. Coverage areas of different base stations (including coverage areas of base stations of the same or different types, coverage areas using the same or different radio technologies, or coverage areas belonging to the same or different access networks) may overlap.

A communication link in the wireless communications system may include an uplink for carrying uplink (UL) transmission (for example, from the user equipment 11 to the network side device 12), or a downlink for carrying downlink (DL) transmission (for example, from the network side device 12 to the user equipment 11). The UL transmission may also be referred to as reverse link transmission, and the DL transmission may also be referred to as forward link transmission. The downlink transmission may be performed over a licensed frequency band, an unlicensed frequency band, or the both. Similarly, the uplink transmission may be performed over a licensed frequency band, an unlicensed frequency band, or the both.

For carrier aggregation (CA), UE may be configured to be work on a plurality of different frequencies (that is, over carriers (Component Carrier, CC) with different absolute radio frequency channel numbers (ARFCN)). The CA includes one primary cell (PCell) and one or more secondary cells (SCells). As shown in FIG. 2, each carrier is a specific serving cell, is configured with a corresponding serving cell identifier (for example, servingCellld), and corresponds to one hybrid automatic repeat request (HARQ) entity. The HARQ entity includes a plurality of HARQ processes. Configuration of one serving cell includes common cell configuration applicable to all UEs in the cell and dedicated cell configuration only applicable to specific UE. LCH means logical channel, MCG means master cell group, De-/Multiplexing means demultiplexing/multiplexing, and PHY means physical layer.

In a case in which UE has a connection failure (for example, a radio link failure, a handover failure, or a radio resource control (RRC) configuration failure), an RRC connection re-establishment procedure is triggered, and connection re-establishment request information (for example, a message of RRCReestablishmentRequest) is transmitted. To find configuration context information corresponding to the UE at a network side, the UE reports a UE identifier in the connection re-establishment request information. Information about the UE identifier includes:

a cell radio network temporary identifier (C-RNTI);

a physical cell identifier (PCI) of a PCell to which the UE is connected before the failure; and

first 16 bits of message authentication code-integrity (MAC-I), that is, Short MAC-I, calculated based on security configuration of the PCell (for example, a source PCell before a handover failure or a PCell having a radio link failure) to which the UE is connected before the failure.

For one specific cell, at most four bandwidth parts (BWPs) may be configured at the network side, corresponding to different ranges of working frequencies. The network side may indicate an activated BWP by using downlink control information (DCI). For one specific cell, the UE can only have one activated BWP at a same moment.

In a conventional technology, the UE can only be configured with a plurality of cells having different frequency points. However, when the UE needs to work at a plurality of TRPs on a same frequency, the UE needs to be capable of transmitting and receiving data at the plurality of nodes. How to configure the UE so that there are proper resources reserved for the UE so as to ensure more effective data transmission and reception is a problem to be solved.

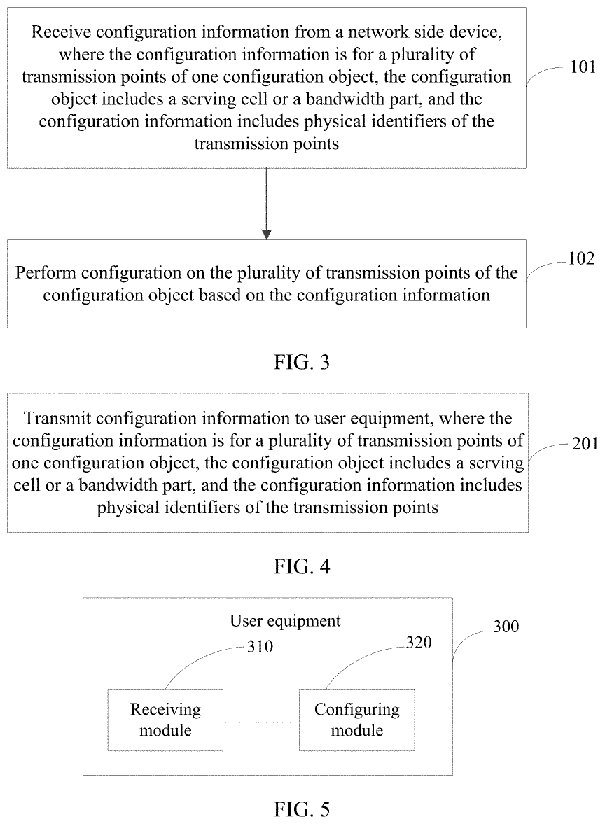

An embodiment of the present disclosure provides a transmission point configuration method, applied to user equipment. As shown in FIG. 3, the method includes:

Step 101: receiving configuration information from a network side device, where the configuration information is for a plurality of transmission points of one configuration object, the configuration object includes a serving cell or a bandwidth part, and the configuration information includes physical identifiers of the transmission points; and

Step 102: performing configuration on the plurality of transmission points of the configuration object based on the configuration information.

The physical identifiers of the transmission points may include at least one of the following:

a physical cell identifier PCI;

an identifier of a reference signal, for example, a synchronization signal block (SSB) and/or a channel state information-reference signal (CSI-RS);

an identifier of a port corresponding to the reference signal, for example, port_1;

an identifier of a resource location of a control channel, for example, a control resource set (CORESET) identifier of a physical downlink control channel (PDCCH) and/or a search space identifier;

an identifier of a reference signal of the control channel, for example, an SSB identifier and/or a CSI-RS identifier; and

an identifier of a port corresponding to the reference signal of the control channel, for example, port_1.

The plurality of transmission points are distinguished from each other by using the physical identifiers of the transmission points. For example, a working frequency point of serving cell-1 or BWP-1 is f1, and the network side device configures a plurality of transmission points PCI-1, PCI-2, PCI-3, and PCI-4 for serving cell-1 or BWP-1.

The plurality of transmission points may be transmission points on a same frequency of the configuration object, or may be transmission points on different frequencies of the configuration object.

In this embodiment, the network side device transmits, to the user equipment, the configuration information for the plurality of transmission points of one configuration object. The user equipment may perform configuration on the plurality of transmission points of the configuration object based on the configuration information. According to the technical solutions in the embodiments, a plurality of transmission points may be configured for the user equipment along with proper resource reservation, for example, one C-RNTI is configured for a plurality of transmission points on a same frequency but with different PCIs, thereby ensuing more effective data transmission and reception of the user equipment at the plurality of transmission points.

Because data reception or transmission at the plurality of transmission points corresponds to one serving cell or BWP, the data reception or transmission at the plurality of transmission points is performed according to a HARQ process in a same HARQ entity.

For the serving cell or BWP configured with the plurality of transmission points, the configuration information of the plurality of transmission points is included in the serving cell or BWP. For example, for serving cell-1, PCI-1 of the serving cell-1 includes one set of configuration information specific to the serving cell, and PCI-2 of the serving cell-1 further includes one set of configuration information specific to the serving cell.

In some embodiments, the configuration information further includes at least one of the following:

an uplink frequency or a downlink frequency;

an uplink or downlink bandwidth;

uplink or downlink numerology;

ratios of subframes or slots between uplink and downlink;

a timing advance offset parameter in uplink;

a System Frame Number (SFN);

a subframe number;

a slot number; and

time domain location configuration information of an SSB, for example, a transmission periodicity of the SSB (for example, ssb-periodicityServingCell) and/or a transmission time domain location of the SSB (for example, ssb-PositionsInBurst).

In some embodiments, working frequencies for uplink or downlink of the plurality of transmission points are the same; and/or

working bandwidths for uplink or downlink of the plurality of transmission points are the same; and/or

working numerology for uplink or downlink of the plurality of transmission points is the same, for example, subcarrier spacings (SCS) have to be the same; and/or

ratios of subframes or slots between uplink and downlink of the plurality of transmission points in operation are the same; and/or

timing advance offset parameters in uplink of the plurality of transmission points in operation are the same, for example, the timing advance offset parameters n-TimingAdvanceOffset in uplink of the plurality of transmission points in operation have to be the same; and/or

SFNs of the plurality of transmission points in operation are synchronized; and/or

subframe numbers of the plurality of transmission points in operation are synchronized;

and/or

slot numbers of the plurality of transmission points in operation are synchronized.

In some embodiments, the transmission point configuration method further includes:

receiving initial transmission point indication information from the network side device, where the initial transmission point indication information indicates a transmission point by default or initially activated when the configuration object is activated.

In a case in which one serving cell or BWP is configured with plurality of corresponding transmission points, the network side device may additionally indicate a transmission point by default or initially activated when the serving cell or BWP is activated. For example, the network side device configures four transmission points (such as PCI-1, PCI-2, PCI-3, and PCI-4) for serving cell-1, and the network side device additionally indicates that transmission points by default or initially activated when serving cell-1 is activated are PCI-1 and PCI-2.

In some embodiments, the transmission point configuration method further includes:

receiving primary transmission point indication information from the network side device, where the primary transmission point indication information indicates a primary transmission point in the plurality of transmission points.

In a case in which one serving cell or BWP is configured with plurality of corresponding transmission points, the network side device may further additionally indicate a primary transmission point (for example, a primary/anchor PCI) corresponding to the serving cell or BWP. For example, the network side configures four transmission points (such as PCI-1, PCI-2, PCI-3, and PCI-4) for serving cell-1, and the network side device additionally indicates that a primary/anchor PCI of serving cell-1 is PCI-1.

In some embodiments, the primary transmission point is in an activated state throughout, for example, cannot be deactivated in a case in which the serving cell or BWP is activated.

In some embodiments, after the user equipment triggers a connection re-establishment procedure, the method further includes:

transmitting connection re-establishment request information to the network side device, where an identifier of the user equipment and an identifier of a specific transmission point corresponding to a serving cell of the user equipment before a connection failure are carried in the connection re-establishment request information, where the identifier of the user equipment may be C-RNTI; and

receiving connection re-establishment information from the network side device, and re-establishing a connection based on the connection re-establishment information, where the network side device may transmit the connection re-establishment information to re-establish a connection to the UE based on the UE identifier (for example, C-RNTI) reported by the UE and the identifier of the specific transmission point corresponding to the serving cell of the UE before a connection failure.

When a connection is established and re-established, the UE can be correctly identified by using a specific PCI in this embodiment.

In some embodiments, the identifier of the specific transmission point includes at least one of the following:

identifiers of all transmission points of a primary cell PCell before the user equipment transmits the connection re-establishment request information, where for example, the PCell is configured with transmission points PCI-1, PCI-2, PCI-3, and PCI-4, and the UE reports PCI-1, PCI-2, PCI-3, and PCI-4;

an identifier of an activated transmission point of the PCell before the user equipment transmits the connection re-establishment request information, where for example, the PCell is configured with the transmission points PCI-1, PCI-2, PCI-3, and PCI-4, PCI-1 and PCI-2 are activated, and the UE reports PCI-1 and PCI-2;

an identifier of a primary transmission point or an identifier of a transmission point by default of the PCell before the user equipment transmits the connection re-establishment request information, where for example, the PCell is configured with the transmission points PCI-1, PCI-2, PCI-3, and PCI-4, the identifier of the primary transmission point or the transmission point by default is PCI-1, and the UE reports PCI-1; and

an identifier of any one of the plurality of transmission points configured for the PCell before the user equipment transmits the connection re-establishment request information, where for example, the PCell is configured with transmission points PCI-1, PCI-2, PCI-3, and PCI-4, and the UE reports PCI-1, PCI-2, PCI-3, or PCI-4.

In some embodiments, the re-establishing a connection based on the connection re-establishment information includes at least one of the following:

using configuration of the primary transmission point or configuration of the transmission point by default of the PCell before the user equipment transmits the connection re-establishment request information as configuration of the PCell after the user equipment re-establishes a connection, where for example, the PCell is configured with the transmission points PCI-1, PCI-2, PCI-3, and PCI-4 before a connection failure, the primary transmission point or the transmission point by default is PCI-1, and the in this case, the configuration of the PCell after the UE re-establishes the connection includes the configuration of the primary transmission point or the transmission point by default PCI-1 of the PCell before the connection failure;

using configuration of the activated transmission point of the PCell before the user equipment transmits the connection re-establishment request information as configuration of the PCell after the user equipment re-establishes a connection, where for example, the PCell is configured with the transmission points PCI-1, PCI-2, PCI-3, and PCI-4 before a connection failure, activated transmission points are PCI-1 and PCI-2, and the in this case, the configuration of the PCell after the UE re-establishes the connection includes configuration of the activated transmission points PCI-1 and PCI-2 of the PCell before the connection failure;

using configuration of all transmission points of the PCell before the user equipment transmits the connection re-establishment request information as configuration of the PCell after the user equipment re-establishes a connection, where for example, the PCell is configured with the transmission points PCI-1, PCI-2, PCI-3, and PCI-4 before a connection failure, and the in this case, the configuration of the PCell after the UE re-establishes the connection includes configuration of PCI-1, PCI-2, PCI-3, and PCI-4 of the PCell before the connection failure; and

using configuration of any one of the plurality of transmission points of the PCell before the user equipment transmits the connection re-establishment request information as configuration of the PCell after the user equipment re-establishes a connection, where for example, the PCell is configured with the transmission points PCI-1, PCI-2, PCI-3, and PCI-4 before a connection failure, and the in this case, the configuration of the PCell after the UE re-establishes the connection includes configuration of PCI-1, PCI-2, PCI-3, or PCI-4 of the PCell before the connection failure.

An embodiment of the present disclosure further provides a transmission point configuration method, applied to a network side device. As shown in FIG. 4, the method includes:

Step 201: transmitting configuration information to user equipment, where the configuration information is for a plurality of transmission points of one configuration object, the configuration object includes a serving cell or a bandwidth part, and the configuration information includes physical identifiers of the transmission points.

The physical identifiers of the transmission points include at least one of the following:

a physical cell identifier PCI;

an identifier of a reference signal, for example, an SSB and/or a CSI-RS;

an identifier of a port corresponding to the reference signal, for example, port_1;

an identifier of a resource location of a control channel, for example, a CORESET identifier of a PDCCH and/or a search space identifier;

an identifier of a reference signal of the control channel, for example, an SSB identifier and/or a CSI-RS identifier; and

an identifier of a port corresponding to the reference signal of the control channel, for example, port_1.

The plurality of transmission points are distinguished from each other by using the physical identifiers of the transmission points. For example, a working frequency point of serving cell-1 or BWP-1 is f1, and the network side device configures a plurality of transmission points PCI-1, PCI-2, PCI-3, and PCI-4 for serving cell-1 or BWP-1.

The plurality of transmission points may be transmission points on a same frequency of the configuration object, or may be transmission points on different frequencies of the configuration object.

In this embodiment, the network side device transmits, to the user equipment, the configuration information for the plurality of transmission points of one configuration object. The user equipment may perform configuration on the plurality of transmission points of the configuration object based on the configuration information. According to the technical solutions in the embodiments, a plurality of transmission points may be configured for the user equipment along with proper resource reservation, for example, one C-RNTI is configured for a plurality of transmission points on a same frequency but with different PCIs, thereby ensuing more effective data transmission and reception of the user equipment at the plurality of transmission points.

In some embodiments, the configuration information further includes at least one of the following:

an uplink frequency or a downlink frequency;

an uplink or downlink bandwidth;

uplink or downlink numerology;

ratios of subframes or slots between uplink and downlink;

a timing advance offset parameter in uplink;

a System Frame Number (SFN);

a subframe number;

a slot number; and

time domain location configuration information of an SSB, for example, a transmission periodicity and/or a transmission time-domain location of the SSB.

In some embodiments, working frequencies for uplink or downlink of the plurality of transmission points are the same; and/or

working bandwidths for uplink or downlink of the plurality of transmission points are the same; and/or

working numerology for uplink or downlink of the plurality of transmission points is the same, for example, subcarrier spacings have to be the same; and/or

ratios of subframes or slots between uplink and downlink of the plurality of transmission points in operation are the same; and/or

timing advance offset parameters in uplink of the plurality of transmission points in operation are the same, for example, the timing advance offset parameters n-TimingAdvanceOffset in uplink of the plurality of transmission points in operation have to be the same; and/or

SFNs of the plurality of transmission points in operation are synchronized; and/or

subframe numbers of the plurality of transmission points in operation are synchronized; and/or

slot numbers of the plurality of transmission points in operation are synchronized.

In some embodiments, the transmission point configuration method further includes:

transmitting initial transmission point indication information to the user equipment, where the initial transmission point indication information indicates a transmission point by default or initially activated when the configuration object is activated.

In a case in which one serving cell or BWP is configured with plurality of corresponding transmission points, the network side device may additionally indicate a transmission point by default or initially activated when the serving cell or BWP is activated. For example, the network side device configures four transmission points (such as PCI-1, PCI-2, PCI-3, and PCI-4) for serving cell-1, and the network side device additionally indicates that transmission points by default or initially activated when serving cell-1 is activated are PCI-1 and PCI-2.

In some embodiments, the transmission point configuration method further includes:

transmitting primary transmission point indication information to the user equipment, where the primary transmission point indication information indicates a primary transmission point in the plurality of transmission points.

In a case in which one serving cell or BWP is configured with plurality of corresponding transmission points, the network side device may further additionally indicate a primary transmission point (for example, a primary/anchor PCI) corresponding to the serving cell or BWP. For example, the network side configures four transmission points (such as PCI-1, PCI-2, PCI-3, and PCI-4) for serving cell-1, and the network side device additionally indicates that a primary/anchor PCI of serving cell-1 is PCI-1.

In some embodiments, the primary transmission point is in an activated state throughout, for example, cannot be deactivated in a case in which the serving cell or BWP is activated.

In some embodiments, after the user equipment triggers a connection re-establishment procedure, the method further includes:

receiving connection re-establishment request information from the user equipment, where an identifier of the user equipment and an identifier of a specific transmission point corresponding to a serving cell of the user equipment before a connection failure are carried in the connection re-establishment request information, where the identifier of the user equipment may be C-RNTI; and

transmitting connection re-establishment information to the user equipment, where the network side device may transmit the connection re-establishment information to re-establish a connection to the UE based on the UE identifier (for example, C-RNTI) reported by the UE and the identifier of the specific transmission point corresponding to the serving cell of the UE before a connection failure.

When a connection is established and re-established, the UE can be correctly identified by using a specific PCI in this embodiment.

In some embodiments, the identifier of the specific transmission point includes at least one of the following:

identifiers of all transmission points of a primary cell PCell before the user equipment transmits the connection re-establishment request information, where for example, the PCell is configured with transmission points PCI-1, PCI-2, PCI-3, and PCI-4, and the UE reports PCI-1, PCI-2, PCI-3, and PCI-4;

an identifier of an activated transmission point of the PCell before the user equipment transmits the connection re-establishment request information, where for example, the PCell is configured with the transmission points PCI-1, PCI-2, PCI-3, and PCI-4, PCI-1 and PCI-2 are activated, and the UE reports PCI-1 and PCI-2;

an identifier of a primary transmission point or an identifier of a transmission point by default of the PCell before the user equipment transmits the connection re-establishment request information, where for example, the PCell is configured with the transmission points PCI-1, PCI-2, PCI-3, and PCI-4, the identifier of the primary transmission point or the transmission point by default is PCI-1, and the UE reports PCI-1; and

an identifier of any one of the plurality of transmission points configured for the PCell before the user equipment transmits the connection re-establishment request information, where for example, the PCell is configured with transmission points PCI-1, PCI-2, PCI-3, and PCI-4, and the UE reports PCI-1, PCI-2, PCI-3, or PCI-4.

As shown in FIG. 5, user equipment 300 in an embodiment of the present disclosure includes a transmission point configuration apparatus, and can implement the transmission point configuration method applied to user equipment described in the foregoing embodiments with the same effects. The user equipment 300 includes the following functional modules:

a receiving module 310, configured to receive configuration information from a network side device, where the configuration information is for a plurality of transmission points of one configuration object, the configuration object includes a serving cell or a bandwidth part, and the configuration information includes physical identifiers of the transmission points; and

a configuring module 320, configured to perform configuration on the plurality of transmission points of the configuration object based on the configuration information.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

In some embodiments, the receiving module is further configured to:

receive initial transmission point indication information from the network side device, where the initial transmission point indication information indicates a transmission point by default or initially activated when the configuration object is activated.

In some embodiments, the receiving module is further configured to:

receive primary transmission point indication information from the network side device, where the primary transmission point indication information indicates a primary transmission point in the plurality of transmission points.

In some embodiments, the transmission point configuration apparatus further includes: a transmitting module, configured to transmit connection re-establishment request information to the network side device, where an identifier of the user equipment and an identifier of a specific transmission point corresponding to a serving cell of the user equipment before a connection failure are carried in the connection re-establishment request information, where

the receiving module is further configured to receive connection re-establishment information from the network side device; and

the transmission point configuration apparatus further includes: a re-establishing module, configured to re-establish a connection based on the connection re-establishment information.

To better achieve the foregoing objective, further, FIG. 7 is a schematic structural diagram of hardware of user equipment for implementing the various embodiments of the present disclosure. The user equipment 40 includes, but is not limited to: components such as a radio frequency unit 41, a network module 42, an audio output unit 43, an input unit 44, a sensor 45, a display unit 46, a user input unit 47, an interface unit 48, a memory 49, a processor 410, and a power supply 411. Those skilled in the art may understand that a structure of the user equipment shown in FIG. 7 does not constitute a limitation on the user equipment, and the user equipment may include more or fewer components than those shown in the figure, or combine some components, or have different component arrangements. In this embodiment of the present disclosure, the user equipment includes but is not limited to a mobile phone, a tablet computer, a laptop computer, a palmtop computer, an in-vehicle terminal, a wearable device, a pedometer, and the like.

The processor 410 is configured to receive configuration information from a network side device, where the configuration information is for a plurality of transmission points of one configuration object, the configuration object includes a serving cell or a bandwidth part, and the configuration information includes physical identifiers of the transmission points.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

It should be understood that in this embodiment of the present disclosure, the radio frequency unit 41 may be configured to receive and transmit information, or receive and transmit signals during a call. For example, the radio frequency unit transmits downlink data to the processor 410 for processing after receiving the downlink data from a base station; and transmits uplink data to the base station. Usually, the radio frequency unit 41 includes, but is not limited to, an antenna, at least one amplifier, a transceiver, a coupler, a low noise amplifier, and a duplexer. In addition, the radio frequency unit 41 may communicate with a network and another device through a wireless communications system.

The user equipment provides wireless broadband Internet access to a user by using the network module 42, for example, helps the user receive and send e-mails, browse web pages, and access streaming media.

The audio output unit 43 may convert audio data received by the radio frequency unit 41 or the network module 42 or stored in the memory 49 into an audio signal, and output the audio signal as a sound. In addition, the audio output unit 43 may further provide audio output (for example, call signal receiving sound or message receiving sound) related to a specific function performed by the user equipment 40. The audio output unit 43 includes a loudspeaker, a buzzer, a telephone receiver, and the like.

The input unit 44 is configured to receive an audio signal or a video signal. The input unit 44 may include a graphics processing unit (GPU) 441 and a microphone 442. The graphics processing unit 441 processes image data of a static image or video obtained by an image capture apparatus (such as, a camera) in a video capture mode or an image capture mode. A processed image frame may be displayed on the display unit 46. The image frame processed by the graphics processing unit 441 may be stored in the memory 49 (or another storage medium) or sent by using the radio frequency unit 41 or the network module 42. The microphone 442 may receive sound and can process such sound into audio data. The processed audio data may be converted in a call mode into a format that can be sent by the radio frequency unit 41 to a mobile communication base station for outputting.

The user equipment 40 further includes at least one sensor 45, for example, a light sensor, a motion sensor, and another sensor. In some embodiments, the light sensor includes an ambient light sensor and a proximity sensor. The ambient light sensor may adjust luminance of the display panel 461 based on brightness of ambient light. The proximity sensor may turn off the display panel 461 and/or backlight when the user equipment 40 is moved to an ear. As a type of the motion sensor, an accelerometer sensor may detect magnitude of acceleration in each direction (generally, on three axes), and may detect magnitude and a direction of gravity when being static. The accelerometer sensor may be used for recognizing a terminal gesture (for example, portrait and landscape orientation switching, a related game, or magnetometer posture calibration), a function related to vibration recognition (for example, a pedometer or a strike), or the like. The sensor 45 may further include a fingerprint sensor, a pressure sensor, an iris sensor, a molecular sensor, a gyroscope, a barometer, a hygrometer, a thermometer, an infrared sensor, and the like. Details are not described herein.

The display unit 46 is configured to display information input by a user or information provided for a user. The display unit 46 may include a display panel 461. The display panel 461 may be configured in a form of a liquid crystal display (LCD), an organic light-emitting diode (OLED), or the like.

The user input unit 47 may be configured to receive input digit or character information and generate key signal input related to user setting and function control of the user equipment. For example, the user input unit 47 includes a touch panel 471 and another input device 472. The touch panel 471 is also referred to as a touchscreen, and may collect a touch operation performed by a user on or near the touch panel 471 (for example, an operation performed by a user on the touch panel 471 or near the touch panel 471 by using any proper object or accessory, for example, a finger or a stylus). The touch panel 471 may include two parts: a touch detection device and a touch controller. The touch detection apparatus detects a touch position of the user, detects a signal brought by the touch operation, and transmits the signal to the touch controller. The touch controller receives touch information from the touch detection apparatus, converts the touch information into contact coordinates, transmits the contact coordinates to the processor 410, and can receive and execute a command sent by the processor 410. In addition, the touch panel 471 may be implemented in various types such as a resistor, a capacitor, an infrared ray, or a surface acoustic wave. The user input unit 47 may include other input devices 472 in addition to the touch panel 471. In some embodiments, the another input device 472 may include, but is not limited to, a physical keyboard, functional keys (for example, a volume control key and a switch key), a trackball, a mouse, and a joystick. Details are not described herein again.

Further, the touch panel 471 may cover the display panel 461. When detecting a touch operation on or near the touch panel 471, the touch panel 471 transmits the touch operation to the processor 410 to determine a type of a touch event. Then, the processor 410 provides corresponding visual output on the display panel 461 based on the type of the touch event. In FIG. 5, the touch panel 471 and the display panel 461 are used as two independent components to implement input and output functions of the user equipment. However, in some embodiments, the touch panel 471 and the display panel 461 may be integrated to implement the input and output functions of the user equipment. This is not specifically limited herein.

The interface unit 48 is an interface connecting an external apparatus to the user equipment 40. For example, the external apparatus may include a wired or wireless headset jack, an external power supply (or a battery charger) port, a wired or wireless data port, a storage card port, a port for connecting an apparatus having an identification module, an audio input/output (I/O) port, a video I/O port, a headset jack, or the like. The interface unit 48 may be configured to receive input (for example, data information and power) from the external apparatus and transmit the received input to one or more elements in the user equipment 40, or may be configured to transmit data between the user equipment 40 and the external apparatus.

The memory 49 may be configured to store a software program and various data. The memory 49 may mainly include a program storage area and a data storage area. The program storage area may store an operating system, an application required by at least one function (for example, a sound play function or an image display function), and the like. The data storage area may store data (for example, audio data or an address book) or the like created based on use of a mobile phone. In addition, the memory 49 may include a high-speed random access memory, and may also include a non-volatile memory, such as at least one disk storage device, a flash memory device, or other volatile solid-state memory devices.

The processor 410 is a control center of the user equipment, and connects all parts of the entire user equipment by using various interfaces and lines. By running or executing a software program and/or a module stored in the memory 49 and invoking data stored in the memory 49, the processor performs various functions of the user equipment and data processing, to perform overall monitoring on the user equipment. The processor 410 may include one or more processing units. For example, the processor 410 may be integrated with an application processor and a modem processor. The application processor mainly processes an operating system, a user interface, an application program, and the like, and the modem processor mainly processes wireless communication. It can be understood that, in some embodiments, the modem processor may not be integrated into the processor 410.

The user equipment 40 may further include a power supply 411 (such as a battery) that supplies power to each component. For example, the power supply 411 may be logically connected to the processor 410 by using a power management system, to implement functions such as charging, discharging, and power consumption management by using the power management system.

In addition, the user equipment 40 includes some functional modules not shown, and details are not described herein.

An embodiment of the present disclosure further provides a communications device, including a processor 410, a memory 49, and a computer program that is stored in the memory 49 and that can run on the processor 410. When the computer program is executed by the processor 410, the processes of the transmission point configuration method embodiments are implemented, and same technical effects can be achieved. To avoid repetition, details are not described herein again.

The communications device may be user equipment. The user equipment may be a device that provides a user with voice and/or other service data connectivity, a handheld device having a wireless connection function, or another processing device connected to a wireless modem. A wireless terminal may communicate with one or more core networks through a radio access network (RAN), and the wireless terminal may be a mobile terminal, such as a mobile telephone (or referred to as a cellular telephone) and a computer with a mobile terminal. For example, the wireless terminal may a portable mobile apparatus, a pocket mobile apparatus, a handheld mobile apparatus, a computer built-in mobile apparatus or a vehicle-mounted mobile apparatus, which exchange language and/or data with a radio access network, For example, a personal communication service (PCS) telephone, a cordless telephone, a session initiation protocol (SIP) telephone, a wireless local loop (WLL) station, a PDA, and another device. The wireless terminal may also be referred to as a system, a subscriber unit, a subscriber station, a mobile station, a mobile, a remote station, a remote terminal, an access terminal, a user terminal, a user agent, or a user device or user equipment. This is not limited herein.

An embodiment of the present disclosure further provides a computer-readable storage medium. The computer-readable storage medium stores a computer program, where each process in the embodiments of the transmission point configuration method applied to the user equipment side described above is implemented when the computer program is executed by a processor, and same technical effects can be achieved. To avoid repetition, details are not described herein again. The computer-readable storage medium includes, for example, a read-only memory (ROM), a random access memory (RAM), a magnetic disk, or a compact disc.

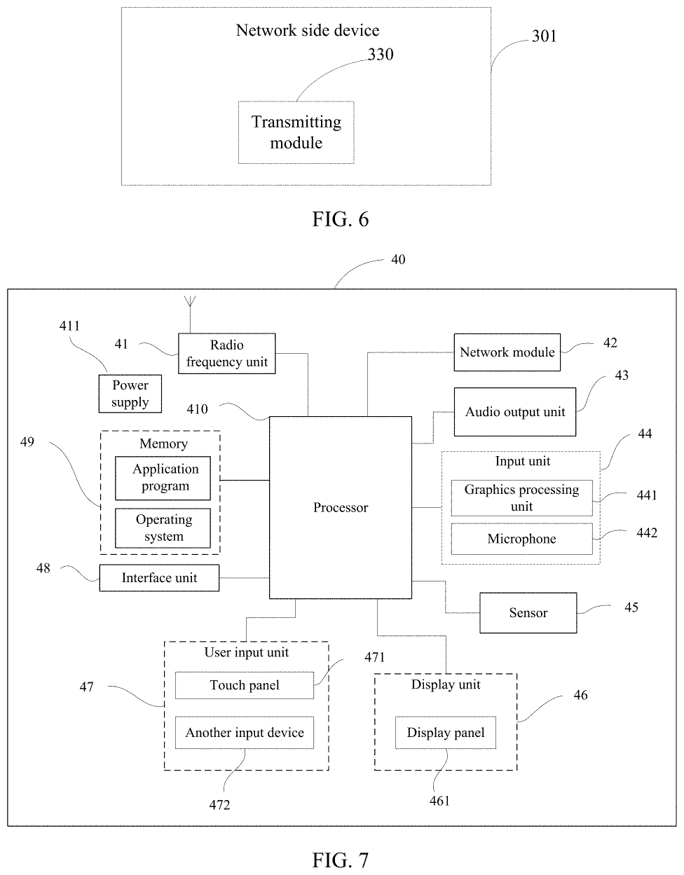

As shown in FIG. 6, a network side device 301 according to an embodiment of the present disclosure includes a transmission point configuration apparatus, and can implement the transmission point configuration method applied to the network side device described in the foregoing embodiments with the same effects. The network side device 301 includes the following functional modules:

a transmitting module 330, configured to transmit configuration information to user equipment, where the configuration information is for a plurality of transmission points of one configuration object, the configuration object includes a serving cell or a bandwidth part, and the configuration information includes physical identifiers of the transmission points.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

In some embodiments, the transmitting module is further configured to:

transmit initial transmission point indication information to the user equipment, where the initial transmission point indication information indicates a transmission point by default or initially activated when the configuration object is activated.

In some embodiments, the transmitting module is further configured to:

transmit primary transmission point indication information to the user equipment, where the primary transmission point indication information indicates a primary transmission point in the plurality of transmission points.

In some embodiments, the transmission point configuration apparatus further includes:

a receiving module, configured to receive connection re-establishment request information from the user equipment, where an identifier of the user equipment and an identifier of a specific transmission point corresponding to a serving cell of the user equipment before a connection failure are carried in the connection re-establishment request information, where

the transmitting module is further configured to transmit connection re-establishment information to the user equipment.

To better achieve the foregoing objective, an embodiment of the present disclosure further provides a network side device, including a processor, a memory, and a computer program that is stored in the memory and that can run on the processor. The steps of the transmission point configuration method described above are implemented when the program is executed by the processor, and same technical effects can be achieved. To avoid repetition, details are not described herein again.

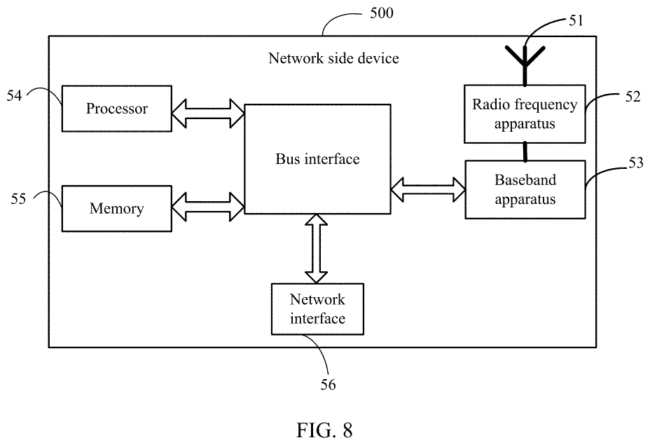

For example, an embodiment of the present disclosure further provides a network side device. As shown in FIG. 8, the network side device 500 includes an antenna 51, a radio frequency apparatus 52, and a baseband apparatus 53. The antenna 51 is connected to the radio frequency apparatus 52. In an uplink direction, the radio frequency apparatus 52 receives information through the antenna 51, and transmits the received information to the baseband apparatus 53 for processing. In a downlink direction, the baseband apparatus 53 processes information to be sent and transmits the information to the radio frequency apparatus 52, and the radio frequency apparatus 52 processes the received information and then transmits the information through the antenna 51.

The foregoing band processing apparatus may be located in the baseband apparatus 53, and the method performed by the network side device in the foregoing embodiment may be implemented in the baseband apparatus 53. The baseband apparatus 53 includes a processor 54 and a memory 55.

The baseband apparatus 53 may include, for example, at least one baseband board, and a plurality of chips are arranged on the baseband board. As shown in FIG. 8, one of the chips is, for example, the processor 54, and is connected to the memory 55, to invoke a program in the memory 55, so as to perform the operations of the network side device shown in the foregoing method embodiment.

The baseband apparatus 53 may further include a network interface 56, which is configured to exchange information with the radio frequency apparatus 52. The interface is, for example, a common public radio interface (CPRI).

The processor herein may be a single processor, or may be a collective term for a plurality of processing elements. For example, the processor may be a CPU or an ASIC, or may be one or more integrated circuits that are configured to implement the foregoing method performed by the network side device, for example, may be one or more microprocessors DSPs, or one or more field programmable gate arrays FPGAs. The storage element may be one memory or a collective term for a plurality of storage elements.

The memory 55 may be a volatile memory or a non-volatile memory, or may include both a volatile memory and a non-volatile memory. Where the non-volatile memory is a ROM, a programmable ROM (PROM), an erasable PROM (EPROM), an electrically EPROM (EEPROM) or a flash memory. The volatile memory may be a RAM, used as an external cache. Through illustrative but not restrictive instructions, RAM with a plurality of forms may be used, for example, a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM) and a direct rambus RAM (DRRAM). The memory 55 described in this application is intended to include but not limited to these and any other suitable types of memories.

In some embodiments, the network side device according to this embodiment of the present disclosure further includes a computer program that is stored in the memory 55 and that can run on the processor 54, where the processor 54 invokes the computer program in the memory 55 to perform the method performed by the modules shown in FIG. 6.

In some embodiments, when invoked by the processor 54, the computer program may be used to transmit configuration information to user equipment, where the configuration information is for a plurality of transmission points of one configuration object, the configuration object includes a serving cell or a bandwidth part, and the configuration information includes physical identifiers of the transmission points.

The physical identifiers of the transmission points include at least one of the following:

a physical cell identifier;

an identifier of a reference signal;

an identifier of a port corresponding to the reference signal;

an identifier of a resource location of a control channel;

an identifier of a reference signal of the control channel; and

an identifier of a port corresponding to the reference signal of the control channel.

An embodiment of the present disclosure further provides a computer-readable storage medium. The computer-readable storage medium stores a computer program, where steps of the transmission point configuration method applied to the network side device described above are implemented when the computer program is executed by a processor, and same technical effects can be achieved. To avoid repetition, details are not described herein again.

Those of ordinary skill in the art may realize that units and algorithm steps of various examples described with reference to the embodiments disclosed in this specification can be implemented by using electronic hardware, or a combination of computer software and the electronic hardware. Whether these functions are performed by using hardware or software depends on a specific application and design constraints of the technical solutions. Those skilled in the art may use different methods to achieve the described functions for each particular application, but such implementation should not be considered as exceeding the scope of the present disclosure.

Those of ordinary skill in the art may clearly understand that, for convenient and simple description, for the specific working processes of the system, apparatus, and unit described above, reference may be made to a corresponding process in the foregoing method embodiments, and details are not described herein again.

In the embodiments provided in this application, it should be understood that the disclosed apparatus and method may be implemented in other manners. For example, the apparatus embodiment described above is only an example. For example, division into the units is only logical function division. There may be other division manners in actual implementation, for example, a plurality of units or components may be combined or integrated into another system, or some features may be ignored or not implemented. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units, that is, may be located in one location, or may be distributed on a plurality of network units. Some or all of the units may be selected according to actual needs to achieve the objective of the solutions of the embodiments.

In addition, functional units in each embodiment of the present disclosure may be integrated into one processing unit, or each of the units may exist alone physically, or two or more units may be integrated in one unit.

If the functions are implemented in a form of software function units and sold or used as independent products, the functions may be stored in a computer-readable storage medium. Based on this understanding, the technical solution, or the part contributing to the prior art or the part of the technical solution may be essentially embodied in the form of software products. The computer software products are stored in a storage medium and includes several instructions for enabling a computer device (which may be a personal computer, a server, or a network side device) to perform all or some of the steps of the method according to the embodiments of the present disclosure. The foregoing storage medium includes various media that can store a program code such as a USB flash disk, a mobile hard disk, a ROM, a RAM, a magnetic disk, an optical disc, or the like.

In addition, it should be noted that, in the method and the apparatus of the present disclosure, obviously, various components or various steps may be decomposed and/or recombined. These division and/or recombination should be considered as equivalent solutions of the present disclosure. Moreover, the steps for performing the foregoing series of processing may be performed naturally in a chronological order according to a described sequence, but do not necessarily need to be performed in the chronological order, and some steps may be performed in parallel or independently. For those of ordinary skill in the art, it can be understood that all or any steps or parts of the method and apparatus of the present disclosure may be implemented in any computing apparatus (including a processor, a storage medium and the like) or a network of the computing apparatus in the form of hardware, firmware, software or their combination, which can be implemented by those of ordinary skill in the art who applies their basic programming skills after reading the description of the present disclosure.

Therefore, the objectives of the present disclosure may also be achieved by running a program or a set of programs on any computing apparatus. The computing apparatus may be a well-known general-purpose apparatus. Therefore, the objective of the present disclosure may also be achieved only by providing a program product including program code for implementing the method or the apparatus. In other words, such a program product also constitutes the present disclosure, and a storage medium storing such a program product also constitutes the present disclosure. Obviously, the storage medium may be any well-known storage medium or any storage medium to be developed in the future. It should be noted that, in the method and the apparatus of the present disclosure, obviously, various components or various steps may be decomposed and/or recombined. These division and/or recombination should be considered as equivalent solutions of the present disclosure. Moreover, the steps for performing the foregoing series of processing may be performed naturally in a chronological order according to a described sequence, but do not necessarily need to be performed in the chronological order. Some steps may be performed in parallel or independently.

The above embodiments are embodiments of the present disclosure. It should be noted that, within the technical concept of the present disclosure, those ordinarily skilled in the art can make various improvements and modifications, which shall all fall within the protective scope of the present disclosure.

What is claimed is:

1. A transmission point configuration method, performed by a user equipment, comprising:
receiving configuration information from a network side device,
wherein:
the configuration information is for a plurality of transmission points of one configuration object,
the configuration object comprises a serving cell or a bandwidth part, and
the configuration information comprises physical identifiers of the transmission points; and
performing configuration on the plurality of transmission points of the configuration object based on the configuration information.

2. The transmission point configuration method according to claim 1, wherein the physical identifiers of the transmission points comprise at least one of the following:
a physical cell identifier;
an identifier of a reference signal;
an identifier of a port corresponding to the reference signal;
an identifier of a resource location of a control channel;
an identifier of a reference signal of the control channel; or
an identifier of a port corresponding to the reference signal of the control channel.

3. The transmission point configuration method according to claim 2, wherein the reference signal comprises at least one of the following:
a synchronization signal block (SSB); or
a channel state information reference signal.

4. The transmission point configuration method according to claim 1, wherein
data reception or transmission at the plurality of transmission points is performed according to a hybrid automatic repeat request (HARQ) process in a same HARQ entity.

5. The transmission point configuration method according to claim 1, wherein the configuration information further comprises at least one of the following:
an uplink frequency or a downlink frequency;
an uplink or downlink bandwidth;
uplink or downlink numerology;
ratios of subframes or slots between uplink and downlink;
a timing advance offset parameter in uplink;
a system frame number (SFN);
a subframe number;
a slot number; or
time domain location configuration information of an SSB.

6. The transmission point configuration method according to claim 5, wherein
working frequencies for uplink or downlink of the plurality of transmission points are the same;
working bandwidths for uplink or downlink of the plurality of transmission points are the same; working numerology for uplink or downlink of the plurality of transmission points is the same;
ratios of subframes or slots between uplink and downlink of the plurality of transmission points in operation are the same;
timing advance offset parameters in uplink of the plurality of transmission points in operation are the same;
SFNs of the plurality of transmission points in operation are synchronized;
subframe numbers of the plurality of transmission points in operation are synchronized; or
slot numbers of the plurality of transmission points in operation are synchronized.

7. The transmission point configuration method according to claim 1, further comprising:
receiving initial transmission point indication information from the network side device, wherein the initial transmission point indication information indicates a transmission point by default or initially activated when the configuration object is activated.

8. The transmission point configuration method according to claim 1, further comprising:
receiving primary transmission point indication information from the network side device, wherein the primary transmission point indication information indicates a primary transmission point in the plurality of transmission points.

9. The transmission point configuration method according to claim 8, wherein the primary transmission point is in an activated state throughout.

10. The transmission point configuration method according to claim 1, further comprising:
transmitting connection re-establishment request information to the network side device, wherein an identifier of the user equipment and an identifier of a specific transmission point corresponding to a serving cell of the user equipment before a connection failure are carried in the connection re-establishment request information; and
receiving connection re-establishment information from the network side device, and re-establishing a connection based on the connection re-establishment information.

11. The transmission point configuration method according to claim 10, wherein the identifier of the specific transmission point comprises at least one of the following:
identifiers of all transmission points of a primary cell (PCell) before the user equipment transmits the connection re-establishment request information;
an identifier of an activated transmission point of the PCell before the user equipment transmits the connection re-establishment request information;
an identifier of a primary transmission point or an identifier of a transmission point by default of the PCell before the user equipment transmits the connection re-establishment request information; or
an identifier of any one of the plurality of transmission points configured for the PCell before the user equipment transmits the connection re-establishment request information.

12. The transmission point configuration method according to claim 10, wherein the re-establishing a connection based on the connection re-establishment information comprises at least one of the following:
using configuration of the primary transmission point or the transmission point by default of the PCell before the user equipment transmits the connection re-establishment request information as configuration of the PCell after the user equipment re-establishes a connection;
using configuration of the activated transmission point of the PCell before the user equipment transmits the connection re-establishment request information as configuration of the PCell after the user equipment re-establishes a connection;
using configuration of all the transmission points of the PCell before the user equipment transmits the connection re-establishment request information as configuration of the PCell after the user equipment re-establishes a connection; or
using configuration of any one of the plurality of transmission points of the PCell before the user equipment transmits the connection re-establishment request information as configuration of the PCell after the user equipment re-establishes a connection.

13. A transmission point configuration method, performed by a network side device, comprising:
transmitting configuration information to a user equipment,
wherein:
the configuration information is for a plurality of transmission points of one configuration object,
the configuration object comprises a serving cell or a bandwidth part, and
the configuration information comprises physical identifiers of the transmission points.

14. The transmission point configuration method according to claim 13, wherein the physical identifiers of the transmission points comprise at least one of the following:
a physical cell identifier;
an identifier of a reference signal;
an identifier of a port corresponding to the reference signal;
an identifier of a resource location of a control channel;
an identifier of a reference signal of the control channel; or
an identifier of a port corresponding to the reference signal of the control channel.

15. The transmission point configuration method according to claim 14, wherein the reference signal comprises at least one of the following:
a synchronization signal slock (SSB);
a channel state information reference signal.

16. The transmission point configuration method according to claim 13, wherein the configuration information further comprises at least one of the following:
an uplink frequency or a downlink frequency;
an uplink or downlink bandwidth;
uplink or downlink numerology;
ratios of subframes or slots between uplink and downlink;
a timing advance offset parameter in uplink;
a system frame number (SFN);
a subframe number;
a slot number; or
time domain location configuration information of an SSB.

17. The transmission point configuration method according to claim 16, wherein
working frequencies for uplink or downlink of the plurality of transmission points are the same;
working bandwidths for uplink or downlink of the plurality of transmission points are the same;
working numerology for uplink or downlink of the plurality of transmission points is the same;
ratios of subframes or slots between uplink and downlink of the plurality of transmission points in operation are the same; timing advance offset parameters in uplink of the plurality of transmission points in operation are the same;
SFNs of the plurality of transmission points in operation are synchronized; subframe numbers of the plurality of transmission points in operation are synchronized; or
slot numbers of the plurality of transmission points in operation are synchronized.

18. The transmission point configuration method according to claim 13, further comprising:
transmitting initial transmission point indication information to the user equipment, wherein the initial transmission point indication information indicates a transmission point by default or initially activated when the configuration object is activated.

19. The transmission point configuration method according to claim 13, further comprising:
transmitting primary transmission point indication information to the user equipment, wherein the primary transmission point indication information indicates a primary transmission point in the plurality of transmission points.

20. A communications device, comprising: a memory having a computer program stored therein; a processor, wherein the computer program, when executed by the processor, causes the processor to perform a transmission point configuration method, comprising:
receiving configuration information from a network side device,
wherein:
the configuration information is for a plurality of transmission points of one configuration object,
the configuration object comprises a serving cell or a bandwidth part, and
the configuration information comprises physical identifiers of the transmission points; and
performing configuration on the plurality of transmission points of the configuration object based on the configuration information.
